(19) United States
(12) Patent Application Publication
(10) Pub. No.: US 2007/0168620 A1
(43) Pub. Date: Jul. 19, 2007

(54) System and method of multi-core cache coherency

(75) Inventors: Judson S. Leonard, Newton, MA (US); Matthew H. Reilly, Stow, MA (US)

Correspondence Address: WILMER CUTLER PICKERING HALE AND DORR LLP, 60 STATE STREET, BOSTON, MA, 02109, US

(73) Assignee: SiCortex, Inc.

(21) Appl. No.: 11/335,421

(22) Filed: Jan. 19, 2006

(51) Int. Cl. G06F 13/28

(52) U.S. Cl. 711/141

(57) ABSTRACT

Systems and methods for cache coherency in multi-processor systems. A cache coherency system is used in a multi-processor computer system having a physical memory system in communication with the processors via a communication medium. A processor-side cache memory subsystem is associated with each processor of the multi-processor computer system. The cache coherency system includes a cache tag memory structure having a number of entries substantially equal to the defined number of entries for each processor-side cache memory. Each entry of the cache tag memory structure has at least one field corresponding to each processor-side cache memory subsystem.

### BACKGROUND

1. Field of the Invention

The invention generally relates to cache memory systems for multiprocessor computer systems.

2. Discussion of Related Art

Modern computer systems depend on memory caches to reduce latency and improve the bandwidth available for memory references. The general idea underlying memory cache is to use high-speed memory to hold a subset of the data or instructions held in the main memory system of the computer. A variety of techniques are known to try to hold the “best” data or instructions in cache memory, i.e., the instructions or data most likely to be used repeatedly by the central processing unit (CPU) and thus gain the maximum benefit from being held in the memory cache.

Many cache designs use something known as “cache tags” to determine whether the cache holds the data for a given memory access. Typically, some hash function (F-index) of the memory address bits of the memory reference is used to index into a cache tag memory structure to select one or more (a “set” of) corresponding tag entries. Another complementary hash function (F-tag) of the address is then compared to each tag of the selected set.

If the F-tag matches any of the selected set of tags, then the cache contains the data for the corresponding memory address; this is referred to as a “cache hit.” Practitioners skilled in the art will appreciate that a cache hit determination may involve more than memory address comparison. For example, it may include things like consideration of ownership status of the data to permit write operations.

If the F-tag does not match any of the selected set of tags, then the cache does not contain the data for the corresponding memory address; this is referred to as a “cache miss.” When a memory access “misses” in the cache, the desired memory contents must be accessed from other memory, such as main memory, a higher-level cache (e.g., when multi-level caching is employed) or perhaps from another cache (e.g., in some multi-processor designs).

Multi-processor systems generally have a separate cache(s) associated with each processor. These systems require a protocol for ensuring the consistency, or coherence, of data values among the caches. That is, for a given memory address, each processor must “see” the identical data value stored at that address when a processor attempts to access data from that address.

There are many cache coherence protocols in use. These protocols are implemented in either hardware or software. The most common approaches are variants of the “snooping” scheme or the “directory” scheme.

In snooping protocols, every time a reference misses in a cache, all other caches are “probed” to determine whether the referenced data is referenced in any of the other caches. Thus each cache must have some mechanism for broadcasting the probe request to all other caches. Likewise the caches must have some mechanism for handling the probe requests. The protocols generally require that the probe requests reach all caches in exactly the same order. The initiating cache must wait for completion of the probe by all other caches. Consequently, these restrictions often result in performance and scalability limitations.

In directory protocols, every reference that misses in cache is sent to the memory controller responsible for the referenced address. The controller maintains a directory with one entry for each block of memory. The directory contents for a given block indicate which processor(s) may have cached copies of the block. If the block is cached anywhere, depending on the block state in the directory and the type of request, the memory controller may need to obtain the block from the cache where it resides, or invalidate copies of the block in any caches which contain copies. This process typically involves a complex exchange of messages.

Directory schemes have a number of disadvantages. They are complex and thus costly and difficult to design and debug, implying extra technical risk. The directory size is proportional to the memory size (not the cache size), resulting in high cost and extra latency. The directory data is not conclusive and instead provides only a hint of where the most recently changed cache data exists. It does not in general provide a reliable indication of where the valid copy of any block in fact may be found. This fact results in extra complexity and handshake latency.

### SUMMARY

The invention provides systems and methods for cache coherency in multi-processor systems. More specifically, the invention provides systems and methods for maintaining cache coherency by using controller-side cache tags that duplicate the contents of the processor-side cache tags.

Under one aspect of the invention, a cache coherency system is used in a multi-processor computer system having a physical memory system in communication with the processors via a communication medium. A processor-side cache memory subsystem is associated with each processor of the multi-processor computer system. Each processor-side cache memory subsystem has a defined number of cache entries for holding a subset of the contents of the physical memory system. The cache coherency system includes a cache tag memory structure having a number of entries substantially equal to the defined number of entries for each processor-side cache memory. Each entry of the cache tag memory structure has at least one field corresponding to each processor-side cache memory subsystem. Each field holds cache tag information to identify which physical memory reference each processor has stored in its corresponding processor-side cache memory subsystem at a corresponding entry in the processor-side cache memory subsystem. In response to a physical memory system request with an associated physical memory address, an entry from the cache tag memory structure is selected. A hash function (F-tag) of memory address bits of the physical memory address is compared with the contents of the selected entry of the cache tag memory structure. A cache hit signature identifies which, if any, processor-side cache memories hold data for the memory reference of interest and is used to cause said identified processor-side cache memory to service said physical memory system request. The selected entry of the cache tag memory structure is modified in response to servicing the physical memory system request.

Under other aspects of the invention, the physical memory may be centralized or distributed.

Under other aspects of the invention, the cache tag memory structure may be centralized or distributed and may reside in the physical memory system or elsewhere.

Under another aspect of the invention, the processor-side cache subsystem is an n-Way set associative cache and each entry in the cache tag memory structure has n fields for each processor. Each field of the n fields corresponds to a different Way in the n-Way associative cache.

Under another aspect of the invention, a hash (F-index) function is used to select an entry from the processor-side cache and to select an entry from the cache tag memory structure.

Under another aspect of the invention, each entry in the processor-side cache is in one state chosen from a set of cache states, and wherein each corresponding field in the controller-side entry is in one state chosen from a subset of the cache states.

Under another aspect of the invention, each processor holds victimized cache entries to service requests to provide such data to another processor cache.

Under another aspect of the invention, a processor re-issues memory system requests if needed to handle in-flight transactions.

Under another aspect of the invention, a memory controller detects that a transaction to memory includes a victim from a processor-side cache that is needed to service the request from another processor.

### BRIEF DESCRIPTION OF THE FIGURES

In the Drawings,

FIG. 1 is a system diagram depicting certain embodiments of the invention;

FIG. 2 depicts memory controller tags according to certain embodiments of the invention;

FIG. 3 depicts an exemplary arrangement for a given entry in memory controller tags according to certain embodiments of the invention; and

FIG. 4 depicts the operation of update logic to update an entry in memory controller tags according to certain embodiments of the invention.

### DETAILED DESCRIPTION

Preferred embodiments of the invention use a duplicate copy of cache tag contents for all processors in the computer system to address the cache coherence problem. Memory references access the duplicate copies and “hits” are used to identify which processor(s) has a copy of the requested data. In certain embodiments the duplicate cache tags are maintained in the physical memory system. The duplicate tag structures are proportional to the cache size (i.e., number of cache entries), not the memory size (unlike directory schemes). In addition, the approach reduces complexity by centralizing information (in the memory controller) to identify which cache(s) have the data of interest.

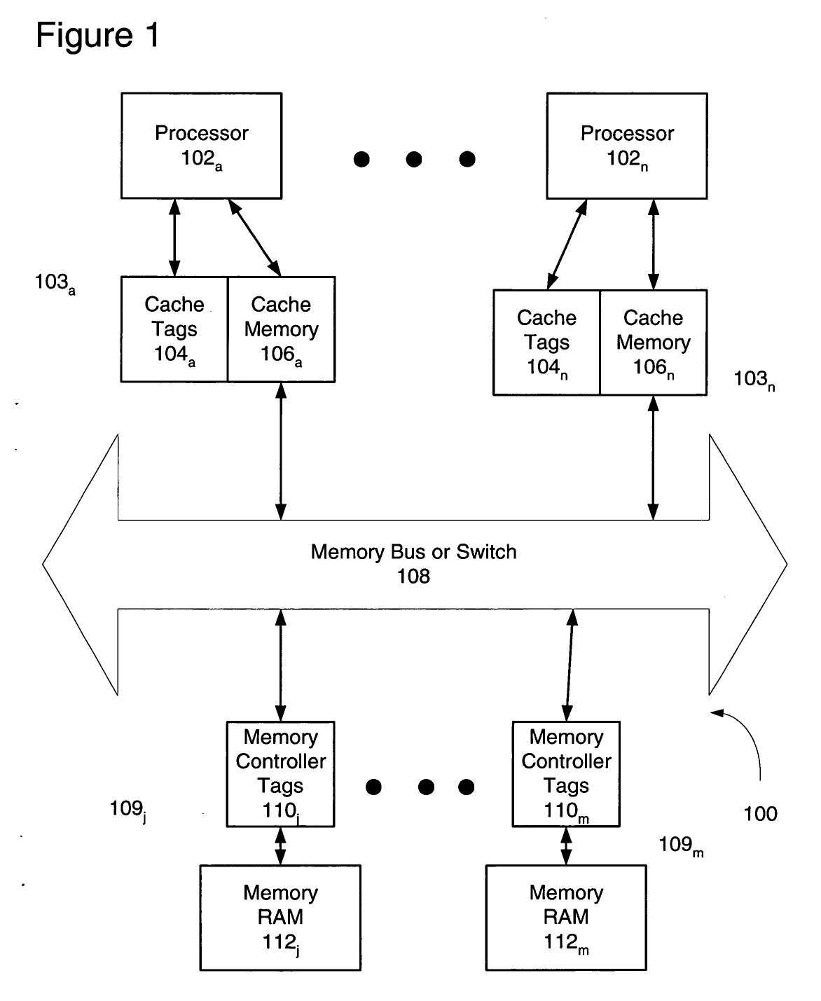

FIG. 1 depicts a multi-processor computer system 100 in accordance with certain embodiments of the invention. A potentially very large number of processors 102a-102n are coupled to a memory bus, switch or fabric 108 via cache subsystems 103a-103n. Each cache subsystem 103 includes cache tags 104 and cache memory 106. The memory bus, switch or fabric 108 also connects a plurality of memory subsystems 109j-109m. The number of memory subsystems need not equal the number of processors. Each memory subsystem 109 includes memory controller tags 110, memory RAM 112, and memory controller logic (not shown).

The processors 102 and cache subsystems 103 need not be of any specific design and may be conventional. Likewise the memory bus switch or fabric 108 need not be of any specific design but can be of a type to interconnect a very large number of processors. Likewise the memory RAMs 112j-112m may be essentially conventional, dividing up the physical memory space of the computer system 100 into various sized “banks” 112j-112m. The cache subsystems 103 may use a fixed or programmable algorithm to determine from the address which bank to access.

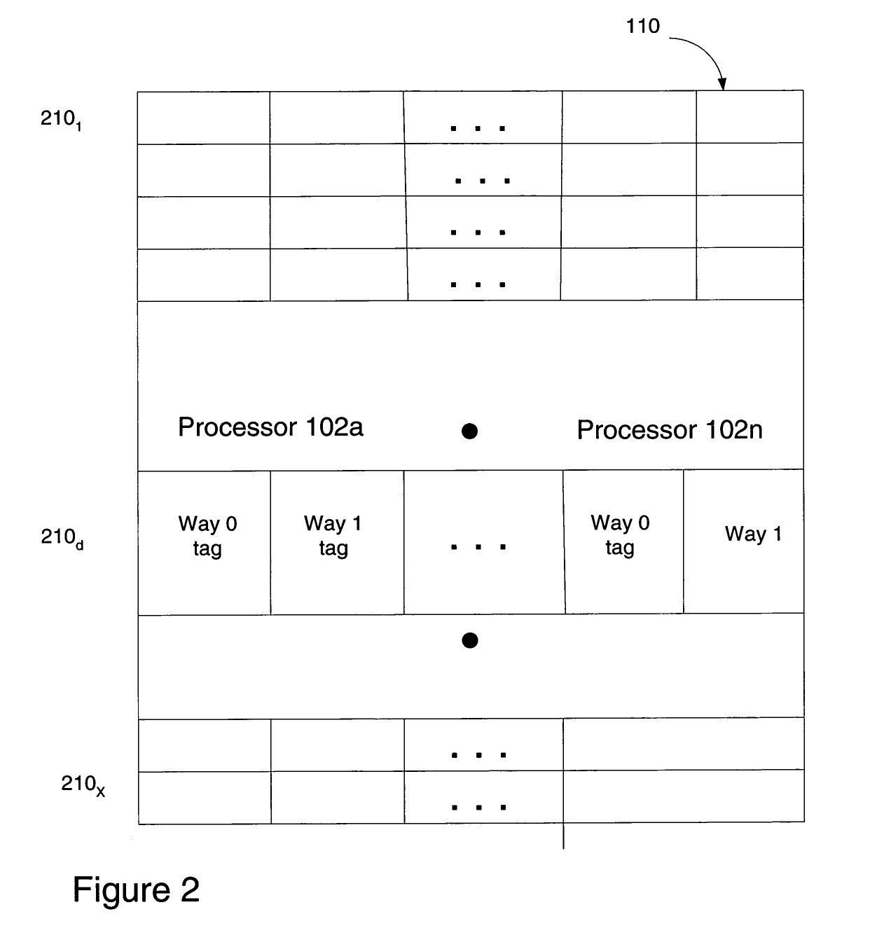

FIG. 2 depicts an exemplary embodiment of memory controller tags 110. As can be seen in FIG. 2, the memory controller tags 110 has a number of entries X that is equal to the number of entries in each of the processor-side cache tags 104. (Unlike directory schemes, the number of entries X is typically much less than the number of memory blocks in memory RAM 112.) Thus, the size of the memory controller tags 110 scales with the size of the processor caches 103 and not the size of the memory RAMs 112. In the depicted embodiment, the caches are 2-way associative so tags for Way0 and Way1 are shown. More generally, the cache may be N-way associative, and each processor would have tags from Way0 to Way(N-1).

In an exemplary embodiment, the cache subsystems 103 use a 2-way set associative design. Consequently, the function F-index of memory address bits used to index into the cache tag structure 104 selects two cache tag entries (one set), each tag corresponding to an entry in cache memory 106 and each having its own value to identify the memory data held in the corresponding entry of cache data memory. (Set associative designs are known, and again, the invention is not limited to any particular cache architecture.)

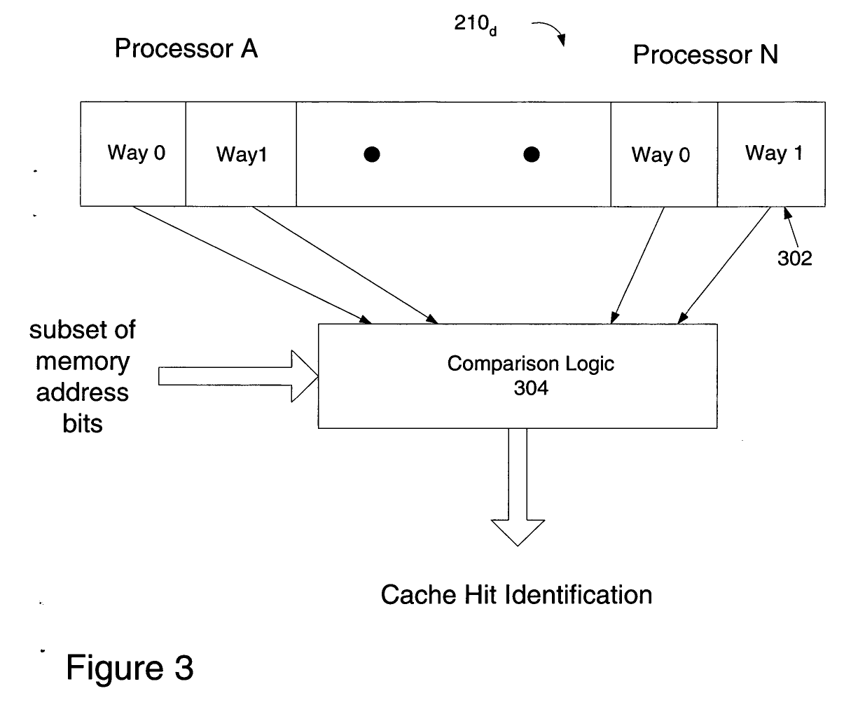

A specific, exemplary entry 210d of the memory controller tags is shown in FIG. 3. As can be seen, each entry includes fields, e.g., 302, to hold duplicate copies of the contents of the tag entries of the processor-side cache tags 104. Thus, for example, memory controller tag entry 210d has copies of each entry ‘d’ for the processor caches 103a-103n. (Entry ‘d’ would be selected by using a function F-index of memory address bits to “index” into the tag structure, e.g., 104 or 110.) Since in this example the cache tag architecture is two-way set associative, the memory controller tags include duplicate copies of the two tag entries that would be found in each processor-side cache tags 104. That is, there is a field for Way0 and another field for Way1 for each processor 102a-n. (In certain embodiments, the controller-side tags need not have a complete duplicate copy of the state bits of the processor-side tags; for example, the controller-side tags may utilize a validity bit but need not include or encode shared states, etc.)

Now that the basic structures have been described, exemplary operation and control logic is described. In certain embodiments, when a processor, e.g., 102a, issues a memory request, the request goes to its corresponding cache subsystem, e.g., 103a, to “see” if the request hits into the processor-side cache. In certain embodiments, in conjunction with determining whether the corresponding cache 103a can service the request, the memory transaction is forwarded via memory bus or switch 108 to a memory subsystem, e.g., 109j, corresponding to the memory address of the request. The request also carries instructions from the processor cache to the memory controller, indicating which “way” of the processor cache is to be replaced.

If the request “hits” into the processor-side cache subsystem 103, then the request is serviced by that cache subsystem, e.g., 103a, for example by supplying to the processor 102a the data in a corresponding entry of the cache data memory 106a. In certain embodiments, the memory transaction sent to the memory subsystem 109j is aborted or never initiated in this case.

In the event that the request misses the processor-side cache subsystem 103a, the memory subsystem 109j will continue with its processing. In such case, as will be explained below, the memory subsystem will then determine if another cache subsystem holds the requested data and determine which cache subsystem should service the request.

With reference to FIG. 3, comparison logic 304 within memory subsystem 109 will compare F-tag of the memory address bits against a corresponding, selected entry, e.g., 210d, of the memory controller tags 110j. The specific entry ‘d’ corresponds to the memory address of interest and is selected by indexing into memory controller tags 110 with F-index of memory address bits. (Practitioners skilled in the art will know that the specific memory address bits will depend on the size of cache blocks, the size of the memory space, the type of interleaving, etc.) The comparison logic 304 essentially executes an “equivalence” function of each field of the entry against F-tag of the memory address bits to be compared. (As mentioned above, the comparison may also consider state or ownership bits. Typically, there is a tag bit (sometimes called “valid”) dedicated to ensuring that no match can occur. Some protocols also provide separate ownership and shared states, such that an owned block is writable by the owner and not readable by any other processor, while a shared block is not writable. Each field in the entry 210d is duplicated tag contents for the processor-side cache tags for each processor cache 103: i.e., entries for Way0 and Way1 for each of the processor caches. (As mentioned above, the state bits of the tag need not be a true duplicate and can instead have only a subset of the processor-side cache states.)

If F-tag of memory address bits does not match any of the entries 210d in the memory controller tags 110 that means the memory transaction refers to an entry not found in any cache 103. This fact will be reflected in the cache hit identification signature. In this instance, the request will need to be serviced by the memory RAM 112, e.g., 112j. The memory RAM 112 will provide the data in case of read operations. The tag entry 210d will be updated accordingly to reflect that processor cache 103a now caches the corresponding memory data for that memory address (updating of tag entries in memory controller tags 110 is discussed below). In the case of writes, the tags will again be updated but no data need be provided to the processor 102a.

If F-tag of memory address bits matches at least one of the entries 210d in the memory controller tags 110 that means the memory transaction refers to an entry found in at least one cache 103. This fact will be reflected in the cache hit identification signature (e.g., multiple set bits in a bitmask). For example, if cache subsystem 103n held the data in Way1, F-tag of memory bits for the memory request would match the contents of field 302 in FIG. 3.

What happens next depends on the requested memory transaction. In the case of a read operation, memory controller logic (not shown) will use the cache hit signature to select one of the processor side caches to service the request. (The memory RAM 112j need not service the request.) Following the example above where cache subsystem 103n held the data in Way1, the memory subsystem 109j provides an instruction to cache 103n saying what data to provide (e.g., data from entry ‘d’, Way1), to whom (e.g., cache 103a), and what to do with its corresponding tag entry on the processor side (e.g., change state, depending on the protocol used). As soon as the look-up of the tag memory request is complete, the entry 210d in the memory controller tags 110 is updated to now reflect that the requesting processor 102a has the data in the way indicated for replacement in the request.

In the case of a write operation, the cache hit signature is used to identify all of the processor-side cache subsystems 103 that now need to have their corresponding cache tag entries invalidated or updated. For example, all Ways corresponding to an entry may be invalidated or just the specific Way holding the relevant data may be invalidated. Certain embodiments change cache state for just the specific Way. The memory controller tags 110 are updated as stated above, i.e., to show that the processors that used to have the data in their respective processor-side cache no longer do and that the processor which issued the write transaction now has the data for that memory address in its cache. Alternatively, the updated data might be broadcast to all those caches, which contain stale copies of the data.

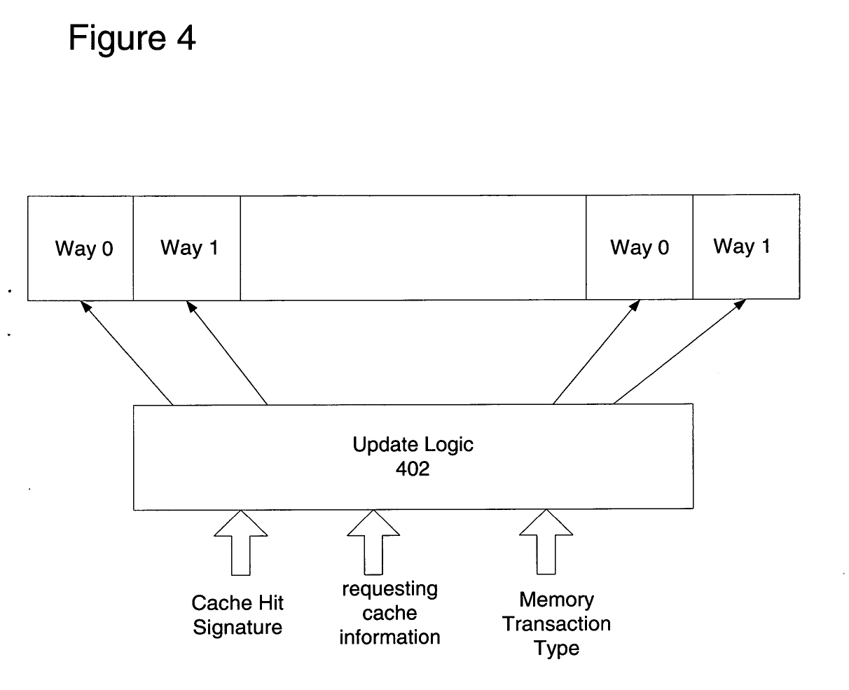

FIG. 4 depicts the entry update logic. The specific entries updated depend on which caches hit and the type of transaction involved. Likewise, the requesting cache information is also used to update the tag entries (i.e., to set the entries in the appropriate set/field for the processor initially issuing the memory request). In certain embodiments, the request from the processor identifies the Way to be replaced by the memory data. In this fashion, the controller knows where to put the new entry in the controller-side tags. Other approaches may be used as well, e.g., controller having logic to identify which Way to replace and to inform the processor accordingly.

During normal operation, cache entries will be victimized. The memory bus or switch may utilize multiple cycles and transactions may be “in flight” that need to be considered. For example, it is possible that a block is being victimized at a processor cache (A) at the same time as it is being requested by another processor (B). There are multiple ways of addressing this issue, and the invention is not particularly limited to any specific way. For example, the processor B may tell the controller to retry the operation. Or, the cache A may hold a copy of its victim until it is no longer possible to see a request and use this copy (victimization buffer) to service such requests. Or, the controller may notice victimization of a block (from A) for which it has an outstanding request (originated from the request of B) and forward the victim to processor B.

Under certain embodiments of the invention, the cache tags identify which processor-side cache will be responsible for providing data to the processor making the request. Due to in flight transactions, that particular processor might not have the data at the particular instance the identification is made, and instead the data of interest may be in flight to that processor. Thus, while it is often correct to say that the cache tags identify which processor-side cache “holds” the data, it is important to realize that due to “in flight time windows” that processor side cache might not yet hold the data (though it will hold it when needed to service the request).

The invention is widely adaptable to various architectural arrangements. Certain embodiments may be utilized in six processor systems (or subsystems), with two banks of memory (1-2 GB each with 64 byte blocks), each processor having 256 KB of cache. Processor-side cache states, in certain embodiments, may include the states valid/invalid, unshared/shared, non-exclusive/exclusive and not-dirty/dirty; and the controller-side cache states may include just the valid/invalid state.

In preferred embodiments, the duplicate tags are stored centrally in the memory controllers. However, other locations are possible with the choice of location being influenced by the architecture of the multi-processor system, including, for example, the choice of memory bus or switch. For example, with certain bus architectures, the duplicate tags may be stored on the processor-side, but this would require full visibility of memory transactions from bus watching or the like.

The controller cache tags may be centrally located or distributed. Likewise the physical memory systems may be centrally located or distributed. Various cache protocols may be utilized as mentioned above. The controller cache tags may duplicate the processor side state bits or use a subset of such bits or a subset of such states. Likewise, various methods of accessing the cache tags may be utilized. The description refers to such access generically via the use of the terminology F-indexes and F-tags to emphasize that the invention is not limited to a particular access technique. In a preferred embodiment, F-index might be the bitwise XOR of low-order and high-order bits of the physical address, whereas F-tag would be a subset of the address bits excluding one of those fields.

It will be further appreciated that the scope of the present invention is not limited to the above-described embodiments but rather is defined by the appended claims, and that these claims will encompass modifications and improvements to what has been described.

What is claimed:

1. A cache coherency system for use in a multi-processor computer system having a physical memory system in communication with the processors via a communication medium and having a processor-side cache memory subsystem associated with each processor of the multi-processor computer system, each processor-side cache memory subsystem having a defined number of cache entries for holding a subset of the contents of the physical memory system, said cache coherency system comprising:
a cache tag memory structure having a number of entries substantially equal to the defined number of entries for each processor-side cache memory, wherein each entry of the cache tag memory structure has at least one field corresponding to each processor-side cache memory subsystem, each field holding cache tag information to identify which physical memory reference each processor has stored in its corresponding processor-side cache memory subsystem at a corresponding entry in the processor-side cache memory subsystem;
comparison logic, responsive to a physical memory system request with an associated physical memory address, to select an entry from the cache tag memory structure and to compare a hash function F-tag of memory address bits of the physical memory address with the contents of the selected entry of the cache tag memory structure, said comparison logic providing a cache hit signature to identify which, if any, processor-side cache memories hold data for the memory reference of interest and to cause said identified processor-side cache memory to service said physical memory system request; and
update logic to modify the selected entry of the cache tag memory structure in response to servicing the physical memory system request.

2. The cache coherency system of claim 1 wherein the physical memory is centralized.

3. The cache coherency system of claim 1 wherein the physical memory is distributed.

4. The cache coherency system of claim 1 wherein the cache tag memory structure is centralized.

5. The cache coherency system of claim 1 wherein the cache tag memory structure is distributed.

6. The cache coherency system of claim 1 wherein the centralized cache tag memory structure resides in the physical memory system.

7. The cache coherency system of claim 6 wherein the physical memory system includes a number of memory modules to subdivide the physical memory address space.

8. The cache coherency system of claim 1 wherein the processor-side cache subsystem is an n-Way set associative cache and wherein each entry in the cache tag memory structure has n fields for each processor, each field of the n fields corresponding to a different Way in the n-Way associative cache.

9. The cache coherency system of claim 1 wherein an F-index hash function is used to select an entry from the processor-side cache and to select an entry from the cache tag memory structure.

10. The cache coherency system of claim 1 wherein each entry in the processor-side cache is in one state chosen from a set of cache states, and wherein each corresponding field in the controller-side entry is in one state chosen from a subset of the cache states.

11. The cache coherency system of claim 1 further including logic to handle in-flight transactions.

12. The cache coherency system of claim 8 wherein the physical memory system request specifies the Way on the processor-side cache that should receive data.

13. The cache coherency system of claim 8 wherein the cache coherency system includes logic to select a Way on the processor side cache to receive data and to instruct the processor-side cache accordingly.

14. A method of maintaining cache coherency in a multi-processor computer system having a physical memory system in communication with the processors via a communication medium and having a processor-side cache memory subsystem associated with each processor of the multi-processor computer system, each processor-side cache memory subsystem having a defined number of cache entries for holding a subset of the contents of the physical memory system, said method comprising:
maintaining a cache tag memory structure having a number of entries substantially equal to the defined number of entries for each processor-side cache memory, such that each entry of the cache tag memory structure has at least one field corresponding to each processor-side cache memory subsystem, and such that each field holds cache tag information to identify which physical memory reference each processor has stored in its corresponding processor-side cache memory subsystem at a corresponding entry in the processor-side cache memory subsystem;
in response to a physical memory system request with an associated physical memory address, selecting an entry from the cache tag memory structure and comparing a hash function F-tag of memory address bits of the physical memory address with the contents of the selected entry of the cache tag memory structure,
providing a cache hit signature to identify which, if any, processor-side cache memories hold data for the memory reference of interest and to cause said identified processor-side cache memory to service said physical memory system request; and
modifying the selected entry of the cache tag memory structure in response to servicing the physical memory system request.

15. The method of claim 14 wherein the physical memory is centralized.

16. The method of claim 14 wherein the physical memory is distributed.

17. The method of claim 14 wherein the cache tag memory structure is maintained in a centralized location.

18. The method of claim 14 wherein the cache tag memory structure is maintained in distributed locations.

19. The method of claim 14 wherein the centralized cache tag memory structure resides in the physical memory system.

20. The method of claim 14 wherein an F-index hash function is used to select an entry from the processor-side cache and to select an entry from the cache tag memory structure.

21. The method of claim 14 wherein each processor holds victimized cache entries to service requests to provide such data to another processor cache.

22. The method of claim 14 wherein a processor re-issues memory system requests if needed to handle in-flight transactions.

23. The method of claim 14 wherein a memory controller detects that a transaction to memory includes a victim from a processor-side cache that is needed to service the request from another processor.

24. The method of claim 14 wherein the processor-side cache is n-Way associative and wherein the physical memory system request specifies the Way on the processor-side cache that should receive data.

25. The method of claim 14 wherein the processor-side cache is n-Way associative and wherein a memory controller selects a Way on the processor side cache to receive data and to instruct the processor-side cache accordingly.
